(19) United States
(12) Patent Application Publication
(10) Pub. No.: US 2016/0214150 A1
(43) Pub. Date: Jul. 28, 2016

(54) NOZZLE COMPONENT AND CONTAINER WASHING APPARATUS USING THE SAME

(71) Applicant: Atsushi Hayashi, Komagane-shi (JP)

(72) Inventors: Yuta Inoue, Nagano (JP); Yuma Isawa, Nagano (JP); Tatsunari Kitajima, Nagano (JP); Santiago Noguchi, Nagano (JP); Kazuki Fujikawa, Nagano (JP)

(73) Assignee: Atsushi Hayashi, Komagane-shi (JP)

(21) Appl. No.: 14/994,232

(22) Filed: Jan. 13, 2016

(30) Foreign Application Priority Data
Jan. 22, 2015 (JP) 2015-010767

(51) Int. Cl. B08B 9/093; B05B 1/14; B08B 3/14

(52) U.S. Cl. CPC B08B 9/093; B08B 3/14; B05B 1/14

(57) ABSTRACT

The present invention intends to provide a container washing apparatus capable of suppressing a positional displacement of a container during washing process with simple structure. A nozzle component includes a nozzle body 103 extending in a predetermined direction, at least one first nozzle for injecting a fluid from the nozzle body in an extending direction of the nozzle body; and at least one second nozzle for injecting the fluid from the nozzle body to an opposite side direction relative to a fluid injecting direction of the first nozzle.

### CROSS-REFERENCE TO RELATED APPLICATIONS

This application claims the benefit and priority of Japanese Patent Application No. 2015-010767, filed Jan. 22, 2015. The entire disclosure of the above application is incorporated herein by reference.

### FIELD

The present disclosure generally relates to a nozzle component and a container washing apparatus using the same.

### BACKGROUND

Recently, a container such as a polyethylene terephthalate (PET) bottle or a glass bottle has used for various objects, such as for foods, beverages, cosmetics, seasonings, pharmaceuticals, etc. These various containers are manufactured in factories or the like and washed using a container washing apparatus prior to shipment. Further, used containers are also washed for reusage.

In a conventional container washing apparatus, a container is provided upside down such that an opening of the container (for example an opening of a PET bottle for beverage) faces downward. Then, the container washing apparatus injects (jet sprays) fluid such as washing liquid upward from the opening toward the inside of the container. Thus, the container washing apparatus washes the internal surface of the container. The container washing apparatus may wash the internal surface of the container by inserting a nozzle into the opening of the container by injecting the fluid from the nozzle being inserted.

However, in a container washing apparatus as described as related art above, due to the pressure of sprayed fluid posed on the inner surface of the container, the container can be displaced while the container is being washed. That is, there is a possibility of upward positional displacement of the container by collision of the fluid onto a surface (for example, a bottom surface of the PET bottle) opposite to the opening of the container. As a result, the conventional container washing apparatus may not be able to wash the container properly. Thus, some of conventional container washing apparatuses to be provided with a stopper to prevent upward positional displacement of the container during washing process. However, if the container washing apparatus is provided with a component such as the stopper, a configuration of the apparatus is likely to be complicated.

### SUMMARY

Accordingly, the present invention intends to provide a nozzle component and a container washing apparatus with a simple configuration capable of suppressing a positional displacement of the container during the washing process.

An embodiment of a nozzle component according to the present invention is a nozzle component for injecting fluid, the component includes a nozzle body extending in a predetermined direction; at least one first nozzle for injecting the fluid supplied from the nozzle body in an extending direction of the nozzle body; and at least one second nozzle for injecting the fluid from the nozzle body to the opposite side direction relative to a fluid injecting direction of the first nozzle.

In an embodiment of the nozzle component, the first nozzle extends from end face (or top end surface) of the nozzle body along the extending direction of the nozzle body, the second nozzle obliquely extends from a side surface of the nozzle body to the opposite side direction relative to the fluid injecting direction of the first nozzle.

An embodiment of a container washing apparatus according to the present invention is a container washing apparatus for washing a container by injecting a fluid, the apparatus includes a nozzle body extending in a predetermined direction; a supply portion for supplying the fluid to the nozzle body; at least one first nozzle for injecting the fluid from the nozzle body in an extending direction of the nozzle body; and at least one second nozzle for injecting the fluid from the nozzle body to an opposite side direction relative to a fluid injecting direction of the first nozzle.

In an embodiment of the container washing apparatus, the first nozzle extends from an end face of the nozzle body along an extending direction of the nozzle body, the second nozzle obliquely extends from a side surface of the nozzle body to an opposite side direction relative to a fluid injecting direction of the first nozzle.

In an embodiment of the container washing apparatus, the nozzle body has an injecting portion for injecting the fluid, the first nozzle injects the fluid toward a first region separated at the injecting portion by a virtual boundary plane perpendicular to the extending direction of the nozzle body, the second nozzle injects the fluid toward a second region separated by the virtual boundary plane.

In an embodiment of the container washing apparatus, the nozzle body extends such that the injecting portion can be inserted into the inside of the container via an opening formed on the container, the second nozzle is configured to inject the fluid from the injecting portion inserted into the inside of the container toward a region in side of the opening, the first nozzle is configured to inject the fluid from the injecting portion inserted into the inside of the container toward a region opposite to the region where the opening exists.

In an embodiment of the container washing apparatus, the nozzle body has a double tubular structure, the first nozzle is in fluid communication with a first nozzle body inside the double tubular structure, the second nozzle is in fluid communication with a second nozzle body outside the double tubular structure, the supply portion supplies the fluid to the first nozzle body via a first flow passage and supplies the fluid to the second nozzle body via a second flow passage, the container washing apparatus further comprising: a first open/close valve for opening/closing the first flow passage; a second open/close valve for opening/closing the second flow passage; and a control unit for controlling the open/close operation of the first open/close valve and the second open/close valve.

In an embodiment of the container washing apparatus, the apparatus further comprising a tank for reserving rain water, wherein the supply portion supplies the rain water after filtrated through a filter and reserved in the tank to the nozzle body.

According to the present invention, for example, it is possible to provide the container washing apparatus capable of suppressing position displacement of the container during washing processes of the container with a simple configuration.

### DRAWINGS

FIG. 1 is a schematic view showing an entire configuration of a container washing apparatus according to the present embodiment.

FIG. 2 is a view showing a detailed configuration of the container washing apparatus according to the present embodiment.

FIG. 3 is a view showing one example of the configuration of a nozzle component according to the present embodiment.

FIG. 4A is a view showing one example of the configuration of a nozzle component according to the present embodiment.

FIG. 4B is a view showing one example of the configuration of a nozzle component according to the present embodiment.

FIG. 5 is a view showing one example of other configuration of a container washing apparatus according to the present embodiment.

### DETAILED DESCRIPTION

Hereinafter, a nozzle component and a container washing apparatus using the same according the present embodiments are described with referring to the attached drawings.

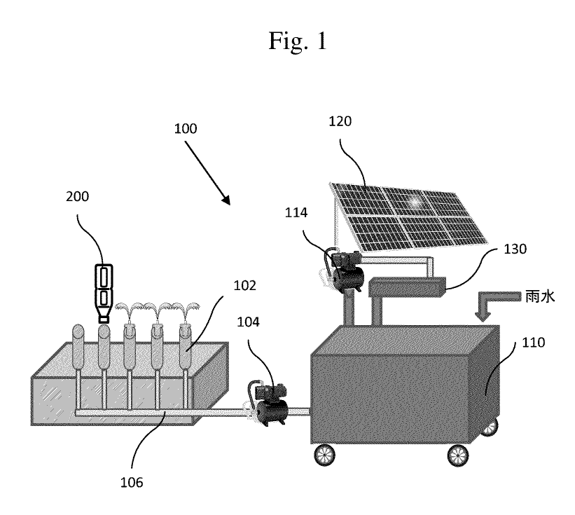

FIG. 1 is a schematic view showing an entire configuration of the container washing apparatus according to the present embodiment. As shown in FIG. 1, the container washing apparatus 100 is a piece of equipment for washing a container 200 such as a PET bottle or a glass bottle by injecting a fluid.

The container washing apparatus 100 includes a nozzle component 102 and a pump 104 as a supply portion for supplying a fluid to the nozzle component 102. The pump 104 and the nozzle component 102 are connected via fluid passage 106.

Further, the container washing apparatus 100 includes a tank 110 for reserving rain water. The pump 104 supplies the rain water reserved in the tank 110 to the nozzle component 102. Specifically, the container washing apparatus 100 includes a pump 114 operated on electricity produced by a solar panel 120 and a filter 130 for filtering rain water. The container washing apparatus 100 filters the rain water by recirculating the rain water reserved in the tank 110 to the filter 130 with use of pump 114. The pump 104 supplies the rain water reserved in the tank 110 and filtrated by the filter 130 to the nozzle component 102.

As shown in FIG. 1, the container 200 placed upside down so that the opening faces downwardly relative to the nozzle component 102. The container washing apparatus 100 washes the container 200 by injecting the filtered rain water from the nozzle component 102 into the inside of the container 200.

Note that, the present embodiment shows an example of washing the container 200 using rain water. However, the rain water may not be used. The container washing apparatus 100, for example, may be used in a manufacturing factory for washing the container 200 made of PET or glass. Further, although the tank 110 of the present embodiment is a movable having wheel(s), the tank 110 may not be movable. Moreover, as shown in FIG. 1, this embodiment shows the example of a plurality of nozzle components 102 are connected to the pump 104. By providing a plurality of nozzle components 102, a plurality of containers 200 can be washed simultaneously. However, the number of nozzle components 102 may not be limited.

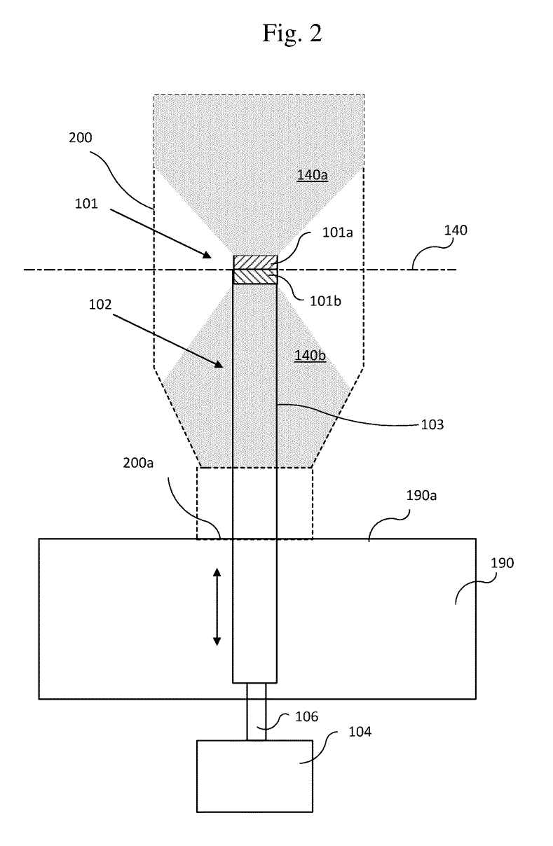

Next, a specific configuration of the container washing apparatus may be described. FIG. 2 shows the specific configuration of the container washing apparatus according to the present embodiment. In FIG. 2, the container 200 and a fixing stage 190 for fixing the nozzle component 200 is drawn by broken lines for the convenience of explanation.

As shown in FIG. 2, the nozzle component 102 includes a nozzle body 103 extending in a predetermined direction and injecting portion 101 disposed at the upper end of the nozzle body 103. In this embodiment, the nozzle body 103 extends downward in a vertical direction into a hole formed on an upper surface of the rectangular fixing stage 190 and fixed to the fixing stage 190. The container 200 may be placed on the fixing stage 190 so that the opening 200a faces downward. The container 200 is placed on the fixing stage 190 with the opening 200a of the container 200 being in contact with the upper surface (a placing surface 190a) of the fixing stage 190. Note that, a spacer may be provided between the opening 200a and the placing surface 190a so that the opening 200a of the container 200 can be away from the placing surface 190a in order to improve drainage of the fluid from the container 200. Alternatively, a gap may be maintained between the opening 200a and the placing surface 190a by inclining the placing surface 190a while disposing the nozzle body 103 along the vertical direction.

The injecting portion 101 is a portion for injecting the rain water outside of the nozzle body 103. The rain water being supplied to the nozzle body 103. Here, it assumes a case in which space with the container 200 is divided into two regions by a virtual boundary surface 140 extending perpendicular to an extending direction of the nozzle body 103 in the injecting portion 101 of the nozzle body 103. The space is divided into a first region 140a and a second region 140b. The injecting portion 101 includes a first nozzle 101a for injecting the fluid toward the first region 140a divided by the virtual boundary surface 140. Further, the injecting portion 101 includes a second nozzle 101b for injecting the fluid toward the second region 140b divided by the virtual boundary surface 140. Note that the nozzle body may be movable in a vertical direction.

Further, as shown in FIG. 2, the nozzle body 103 extends so that the injecting portion 101 can be inserted into the inside of the container 200 via the opening 200a of the container 200. In this case, the second nozzle 101b is configured to be able to inject the fluid from the injecting portion 101 inserted into the inside of the container 200 toward the region in side of the opening 200a (the second region 140b). Further, the first nozzle 101a is configured to be able to inject the fluid from the injecting portion 101 inserted into the inside of the container 200 toward the opposite side region relative to the opening 100a (the first region 140a).

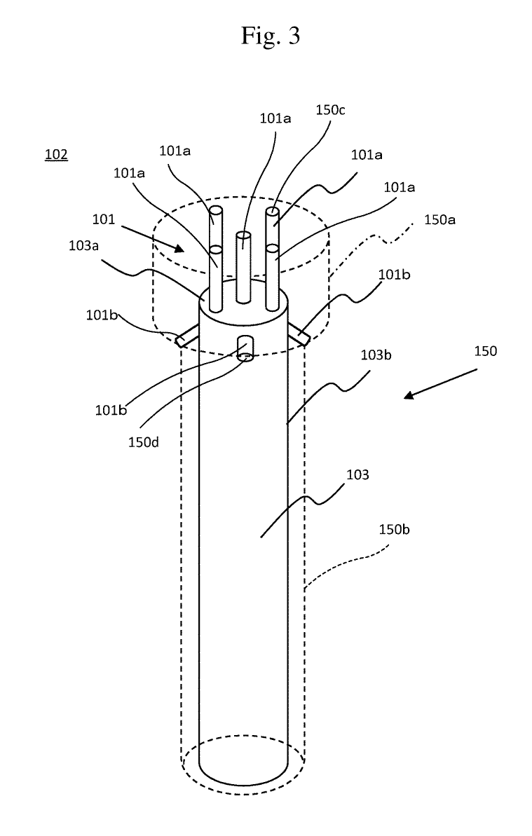

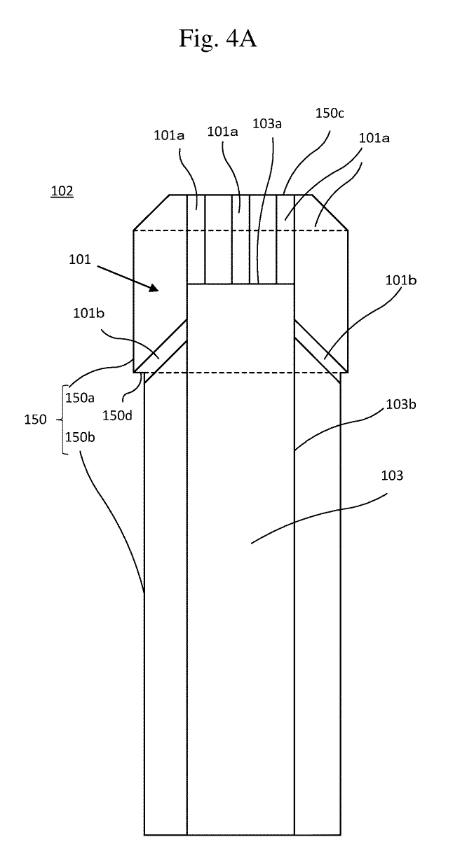

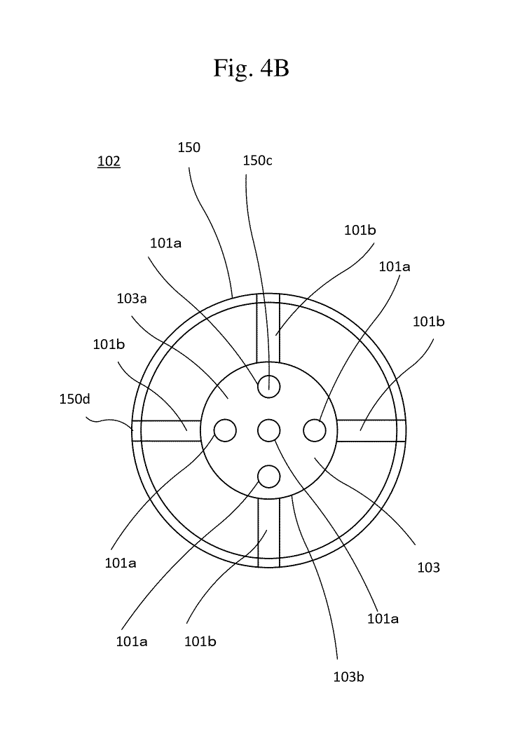

Next, the nozzle component of the present embodiment is described in detail. FIGS. 3 and 4 show one example of configuration of the nozzle component according to the present embodiment. FIG. 3 is a perspective view schematically showing the configuration of the nozzle component. FIG. 4A shows a vertical cross section view of the nozzle component and FIG. 4B shows a plan view of the nozzle component.

As shown in FIGS. 3 and 4, the nozzle component 102 includes a nozzle body 103 extending in a predetermined direction, first nozzles 101a for injecting the fluid (the rain water) from the nozzle body 103 in the extending direction of the nozzle body 103 and second nozzles 101b for injecting the fluid from the nozzle body 103 in a direction opposite to the direction in which the first nozzles 101a inject the fluid.

Specifically, the first nozzle 101a extends from an end face 103a of the nozzle body 103 in the extending direction of the nozzle body 103. As shown in FIGS. 3 and 4B, in this embodiment, the five first nozzles 101a are provided, however, any number of the first nozzle 101a are acceptable. Note that, the first nozzles 101a are not required to be precisely parallel to the extending direction of the nozzle body 103, the first nozzle 101a may be inclined relative to the extending direction.

Further, the second nozzles 101b obliquely extend from the side surface 103b of the nozzle body 103 to the opposite side direction relative to the fluid injecting direction of the first nozzles 101a. For example, if the extending direction of the first nozzles 101a is defined as upward direction, the second nozzles 101b obliquely extend downward from the side surface 103b of the nozzle body 103. As shown in FIG. 4B, in this embodiment, the four second nozzles 101b are provided, any number of the second nozzles 101b are acceptable. Further, as shown in FIG. 4B, the second nozzles 101b may be provided at positions corresponding to the four first nozzles 101a surrounding the center of the first nozzles 101a, respectively. Further, as shown in FIG. 3, the second nozzles 101b may be provided at a position corresponding to interval of the four first nozzles 101a surrounding the center of the first nozzle 101a, respectively. The nozzle body 103 of 10 mm in diameter, for example, may be formed. Further, the first nozzles 101a, and the second nozzles 101b may be formed 1.5 mm in diameter.

Further, the nozzle component 102 includes a housing 150 for covering the nozzle body 103, the first nozzles 101a, and the second nozzles 101b. The housing 150 includes a first housing 150a for mainly covering the injecting portion 101 (the first nozzles 101a, and the second nozzles 101b) and second housing 150b for mainly covering the nozzle body 103. The second housing 150b has a diameter smaller than that of the first housing 150a.

The housing 150 has five openings 150c formed in the end face of the first housing 150a. Each of the five openings 150c is in communication with each of the five first nozzles 101a, respectively. Further, the housing 150 has four openings 150d formed in the connection portion between the first housing 150a and the second housing 150b. Each of the four openings 150d is in communication with each of the second nozzles 101b.

The nozzle component and the container washing apparatus of the present embodiment can suppress the positional displacement of the container 200 during washing process with simple configuration by providing the first nozzles 101a and the second nozzles 101b. That is, since the conventional container washing apparatus merely upwardly injecting the fluid, an upward force is applied to the container 200 by the pressure caused by the fluid injected the inner wall of the container 200 (e.g., the bottom surface of the container 200). As a result, there is a risk that the positional displacement of the container 200 will occur or the container 200 will come off from the nozzle component 102. A stopper as a countermeasure may be provided in order to suppress the upward positional displacement of the container 200 during the washing process or coming off of the container from the nozzle component 102. However, providing the component such as the stopper renders the apparatus configuration complex.

On the other hand, as shown in FIG. 2, the nozzle component 102 and the container washing apparatus 100 of the present embodiment, apply the downward force to the container 200 by means of collision of the fluid injected from the second nozzles 101b to the inner wall of the container 200. This downward force applied on the container 200 can cancel the upward force (the force applied in direction which removes the container 200 from the nozzle component 102) applied to the container 200 by means of collision of the fluid injected from the first nozzle 101a to the inner wall of the container 200. As a result, the container washing apparatus 100 according to the present embodiment can suppress the positional displacement of the container 200 during the washing process with a simple structure without adding a special component, such as a stopper. Note that, at least one of the first nozzles 101a and the second nozzles 101b may be able to inject the fluid having circumferential velocity component toward the inner wall of the container 200. Thus, the container 200 is rotated in response to the injection of the fluid, the inside of the container 200 can be uniformly washed.

Further, the container washing apparatus 100 may firstly inject the fluid from the second nozzles 101b upon washing the container 200, then the injection of the fluid from the first nozzles 101a is started while the fluid being injected from the second nozzles 101b. According to this, the downward force is firstly applied to the container 200, then, the upward force is applied while the downward force is continuously applied. Therefore, the positional displacement of the container 200 during the washing process can be surely suppressed.

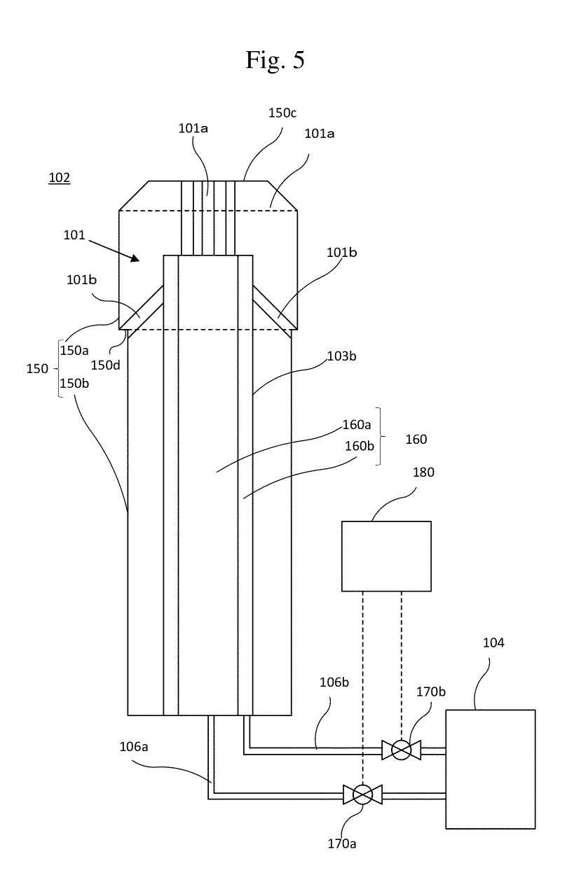

As shown in FIG. 5, the container washing apparatus 100 may include, for example a double tubular nozzle body 160 instead of the nozzle body 103 shown in FIGS. 2, 3, 4A, 4B in order to vary the injection timing of the fluid from the first nozzles 101a and the second nozzles 101b. The nozzle body 160 includes a first nozzle body 160a and the second nozzle body 160b surrounding the outer side of the first nozzle body 160a. The first nozzle 101a extends from the end face of the first nozzle body 160a along the extending direction of the first nozzle body 160a. The second nozzle 101b extends obliquely from the side surface of the second nozzle body 160b in an opposite side direction relative to the fluid injecting direction of the first nozzle 101a. For example, if the extending direction of the first nozzle 101a is defined as the upward direction, the second nozzle 101b extends obliquely downward from the side surface of the second nozzle body 160b.

The pump 104 supplies the fluid to the first nozzle body 160a via a first flow passage 106a. The container washing apparatus 100 includes a first open/close valve 170a provided in the first flow passage 106a. The first open/close valve 170a is a valve capable of opening and closing the first flow passage 106a.

Further, the pump 104 supplies the fluid to the second nozzle body 160b via a second flow passage 106b. The container washing apparatus 100 includes a second open/close valve 170b provided in a second flow passage 106b.

The second open/close valve 170b is a valve capable of opening and closing the second flow passage 106b.

Further, the container washing apparatus 100 includes the control unit 180 which controls the opening/closing of the first open/close valve 170a and the second open/close valve 170b. The control unit 180 closes the first open/close valve 170a and opens the second open/close valve 170b during washing process of the container 200. Accordingly, the fluid from the second nozzles 101b is injected by the control unit 180. Then, the control unit 180 opens the first open/close valve 170a in a state where the second open/close valve 170b opens. Accordingly, the control unit 180 can operate such that the fluid from the first nozzles 101a can be injected while continuously injecting the fluid from the second nozzles 101b. According to this, the downward force is initially applied to the container 200, then the upward force is applied in the state where the downward force is continuously applied to the container 200. Therefore, the positional displacement of the container 200 during the washing process can be surely suppressed.

Note that, in the present embodiment, an example provided with the control unit 180 is described, however, the present invention is not limited thereto. For example, the control unit 180 is not necessary if the first open/close valve 170a and the second open/close valve 170b can be manually opened and closed.

Further, in the present embodiment, an example of the container washing apparatus 100 including the nozzle body 103 extending along the vertical direction is described. However, the present invention is not limited thereto. That is, the nozzle body 103 may extend the arbitrary direction such as oblique direction or lateral direction.

Further, in the above description, each of the technical features has been described in association with each other. Therefore, by combining the technical features, the invention capable of obtaining special technical effect can be qualified as a valid invention. On the other hand, each of the above technical features may be able to define the invention. Accordingly, the invention assumed on the present application is not necessarily limited to the invention defined by combining a plurality of technical features, the present invention can be defined by solo technical feature or any combination of the technical features.

What is claimed is:

1. A nozzle component for injecting fluid, the component comprising:
a nozzle body extending in a predetermined direction;
at least one first nozzle for injecting the fluid from the nozzle body in an extending direction of the nozzle body; and
at least one second nozzle for injecting the fluid from the nozzle body to an opposite side direction relative to a fluid injecting direction of the first nozzle.

2. The nozzle component according to claim 1, wherein
the first nozzle extends from an end face of the nozzle body along the extending direction of the nozzle body, the second nozzle obliquely extends from a side surface of the nozzle body to the opposite side direction relative to the fluid injecting direction of the first nozzle.

3. A container washing apparatus for washing a container by injecting a fluid, the apparatus comprising:
a nozzle body extending in a predetermined direction;
a supply portion for supplying the fluid to the nozzle body;
at least one first nozzle for injecting the fluid from the nozzle body in an extending direction of the nozzle body; and
at least one second nozzle for injecting the fluid from the nozzle body to an opposite side direction relative to a fluid injecting direction of the first nozzle.

4. The container washing apparatus according to claim 3, wherein
the first nozzle extends from an end face of the nozzle body along an extending direction of the nozzle body, the second nozzle obliquely extends from a side surface of the nozzle body to an opposite side direction relative to a fluid injecting direction of the first nozzle.

5. The container washing apparatus according to claim 3, wherein
the nozzle body has an injecting portion for injecting the fluid, the first nozzle injects the fluid toward a first region separated at the injecting portion by a virtual boundary plane perpendicular to the extending direction of the nozzle body, the second nozzle injects the fluid toward a second region separated by the virtual boundary plane.

6. The container washing apparatus according to claim 4, wherein
the nozzle body has an injecting portion for injecting the fluid, the first nozzle injects the fluid toward a first region separated at the injecting portion by a virtual boundary plane perpendicular to the extending direction of the nozzle body, the second nozzle injects the fluid toward a second region separated by the virtual boundary plane.

7. The container washing apparatus according to claim 5, wherein
the nozzle body extends such that the injecting portion can be inserted into an inside of the container via an opening formed on the container, the second nozzle is configured to inject the fluid from the injecting portion inserted into the inside of the container toward a region in side of the opening, the first nozzle is configured to inject the fluid from the injecting portion inserted into the inside of the container toward a region opposite to the region where the opening exists.

8. The container washing apparatus according to claim 6, wherein
the nozzle body extends such that the injecting portion can be inserted into an inside of the container via an opening formed on the container, the second nozzle is configured to inject the fluid from the injecting portion inserted into the inside of the container toward a region in side of the opening, the first nozzle is configured to inject the fluid from the injecting portion inserted into the inside of the container toward a region opposite to the region where the opening exists.

9. The container washing apparatus according to claims 3, wherein
the nozzle body has a double tubular structure, the first nozzle is in fluid communication with a first nozzle body inside the double tubular structure, the second nozzle is in fluid communication with a second nozzle body outside the double tubular structure,
the supply portion supplies the fluid to the first nozzle body via a first flow passage and supplies the fluid to the second nozzle body via a second flow passage,
the container washing apparatus further comprising:
a first open/close valve for opening/closing the first flow passage; a second open/close valve for opening/closing the second flow passage; and a control unit for controlling the open/close operation of the first open/close valve and the second open/close valve.

10. The container washing apparatus according to claim 4, wherein
the nozzle body has a double tubular structure, the first nozzle is in fluid communication with a first nozzle body inside the double tubular structure, the second nozzle is in fluid communication with a second nozzle body outside the double tubular structure,
the supply portion supplies the fluid to the first nozzle body via a first flow passage and supplies the fluid to the second nozzle body via a second flow passage,
the container washing apparatus further comprising:
a first open/close valve for opening/closing the first flow passage; a second open/close valve for opening/closing the second flow passage; and a control unit for controlling the open/close operation of the first open/close valve and the second open/close valve.

11. The container washing apparatus according to claim 5, wherein
the nozzle body has a double tubular structure, the first nozzle is in fluid communication with a first nozzle body inside the double tubular structure, the second nozzle is in fluid communication with a second nozzle body outside the double tubular structure,
the supply portion supplies the fluid to the first nozzle body via a first flow passage and supplies the fluid to the second nozzle body via a second flow passage,
the container washing apparatus further comprising:
a first open/close valve for opening/closing the first flow passage; a second open/close valve for opening/closing the second flow passage; and a control unit for controlling the open/close operation of the first open/close valve and the second open/close valve.

12. The container washing apparatus according to claim 6, wherein
the nozzle body has a double tubular structure, the first nozzle is in fluid communication with a first nozzle body inside the double tubular structure, the second nozzle is in fluid communication with a second nozzle body outside the double tubular structure,
the supply portion supplies the fluid to the first nozzle body via a first flow passage and supplies the fluid to the second nozzle body via a second flow passage,
the container washing apparatus further comprising:
a first open/close valve for opening/closing the first flow passage; a second open/close valve for opening/closing the second flow passage; and a control unit for controlling the open/close operation of the first open/close valve and the second open/close valve.

13. The container washing apparatus according to claim 7, wherein
the nozzle body has a double tubular structure, the first nozzle is in fluid communication with a first nozzle body inside the double tubular structure, the second nozzle is in fluid communication with a second nozzle body outside the double tubular structure,
the supply portion supplies the fluid to the first nozzle body via a first flow passage and supplies the fluid to the second nozzle body via a second flow passage,
the container washing apparatus further comprising:
a first open/close valve for opening/closing the first flow passage; a second open/close valve for opening/closing the second flow passage; and a control unit for controlling the open/close operation of the first open/close valve and the second open/close valve.

14. The container washing apparatus according to claim 8, wherein
the nozzle body has a double tubular structure, the first nozzle is in fluid communication with a first nozzle body inside the double tubular structure, the second nozzle is in fluid communication with a second nozzle body outside the double tubular structure,
the supply portion supplies the fluid to the first nozzle body via a first flow passage and supplies the fluid to the second nozzle body via a second flow passage,
the container washing apparatus further comprising:
a first open/close valve for opening/closing the first flow passage; a second open/close valve for opening/closing the second flow passage; and a control unit for controlling the open/close operation of the first open/close valve and the second open/close valve.

15. The container washing apparatus according to claim 3, the apparatus further comprising a tank for reserving a rain water,
wherein the supply portion supplies the rain water as the fluid cleaned by a filter and reserved in the tank to the nozzle body.

16. The container washing apparatus according to claim 4, the apparatus further comprising a tank for reserving a rain water,
wherein the supply portion supplies the rain water as the fluid cleaned by a filter and reserved in the tank to the nozzle body.

17. The container washing apparatus according to claim 5, the apparatus further comprising a tank for reserving a rain water,
wherein the supply portion supplies the rain water as the fluid cleaned by a filter and reserved in the tank to the nozzle body.

18. The container washing apparatus according to claim 6, the apparatus further comprising a tank for reserving a rain water,
wherein the supply portion supplies the rain water as the fluid cleaned by a filter and reserved in the tank to the nozzle body.

19. The container washing apparatus according to claim 7, the apparatus further comprising a tank for reserving a rain water,
wherein the supply portion supplies the rain water as the fluid cleaned by a filter and reserved in the tank to the nozzle body.

20. The container washing apparatus according to claim 8, the apparatus further comprising a tank for reserving a rain water,
wherein the supply portion supplies the rain water as the fluid cleaned by a filter and reserved in the tank to the nozzle body.
